(19) United States
(12) Patent Application Publication
(10) Pub. No.: US 2013/0121859 A1
(43) Pub. Date: May 16, 2013

(54) BEARING APPARATUS AND FAN

(71) Applicant: Nidec Corporation, Kyoto (JP)

(72) Inventors: Teiichi Hirono, Kyoto (JP); Shinichiro Noda, Kyoto (JP); Yoshiharu Ikegami, Kyoto (JP)

(73) Assignee: NIDEC CORPORATION, Kyoto (JP)

(21) Appl. No.: 13/658,429

(22) Filed: Oct. 23, 2012

(30) Foreign Application Priority Data
Nov. 10, 2011 (JP) 2011-246101

(51) Int. Cl. F04D 29/057; F16C 32/06

(52) U.S. Cl. 417/423.13; 384/107

(57) ABSTRACT

A bearing apparatus includes a cylindrical bearing portion; a cap member; a cylindrical holder; a shaft; and a thrust plate. The holder includes an increased diameter portion. The bearing portion includes a plate accommodating portion. An outer circumferential surface of the plate accommodating portion is arranged to have a diameter greater than a diameter of an outer circumferential surface of a portion of the bearing portion which is on an upper side of the plate accommodating portion. The distance between the outer circumferential surface and an inner circumferential surface of the plate accommodating portion is arranged to be smaller than the distance between the outer circumferential surface and an inner circumferential surface of the portion of the bearing portion which is on the upper side of the plate accommodating portion. A thrust dynamic pressure bearing portion is defined in a thrust gap.

### BACKGROUND OF THE INVENTION

1. Field of the Invention

The present invention relates to a fan and a bearing apparatus using a fluid dynamic pressure.

2. Description of the Related Art

Cooling fans arranged to cool electronic components have typically been installed inside cases of a variety of electronic devices. A fan motor disclosed in JP-UM-B 06-31199 includes a case, a stator, a sleeve, a shaft, an annular member, a rotor, and a plurality of blades. The stator is arranged on an outer circumference of an inner tubular portion of the case. The sleeve is fitted into the inner tubular portion and fixed thereto. The shaft is inserted in the sleeve. Grooves arranged to generate a dynamic pressure are defined in an outer circumferential surface of the shaft. The annular member is fitted on a lower end portion of the shaft and fixed thereto. The annular member is arranged axially opposite a lower surface of the sleeve. Each of a gap defined between the sleeve and the shaft and a gap defined between the sleeve and the annular member is filled with a lubricating fluid. The rotor is fixed to an upper end portion of the shaft. A magnet is fixed to an inner circumference of a cylindrical attachment member of the rotor, and is arranged radially opposite the stator. The blades are fixed to an outer circumference of the attachment member. In the fan motor, a radial dynamic pressure bearing is defined by a combination of the shaft and the sleeve, while a thrust dynamic pressure bearing is defined by a combination of the sleeve and the annular member.

In the case where a bearing apparatus using a fluid dynamic pressure is used in a fan, a thrust dynamic pressure bearing portion arranged to generate a sufficient fluid dynamic pressure needs to be defined because a great lift acts on an impeller during drive of the fan. In particular, sufficient bearing performance is required for large fans, such as 60 mm fans and 80 mm fans.

The present invention has been conceived to improve bearing performance of bearing apparatuses for use in applications such as fans.

### SUMMARY OF THE INVENTION

A bearing apparatus according to a preferred embodiment of the present invention includes a cylindrical bearing portion; a cap member arranged to close a bottom portion of the bearing portion; a cylindrical holder arranged to hold the bearing portion thereinside, and including an outer circumferential surface arranged to have a stator fixed thereto; a shaft inserted in the bearing portion; and a thrust plate arranged to extend radially outward from a lower end portion of the shaft. The holder includes an increased diameter portion arranged to have an outside diameter greater than a diameter of the outer circumferential surface. A portion of the bearing portion which is arranged radially inside the increased diameter portion includes a plate accommodating portion arranged to accommodate the thrust plate thereinside. An outer circumferential surface of the plate accommodating portion is arranged to have a diameter greater than a diameter of an outer circumferential surface of a portion of the bearing portion which is on an upper side of the plate accommodating portion, and a distance between the outer circumferential surface and an inner circumferential surface of the plate accommodating portion is arranged to be smaller than a distance between the outer circumferential surface and an inner circumferential surface of the portion of the bearing portion which is on the upper side of the plate accommodating portion. The bearing portion includes an annular surface arranged axially opposite an upper surface of the thrust plate. A radial dynamic pressure bearing portion arranged to generate a fluid dynamic pressure acting on a lubricating oil is defined in a radial gap defined between an inner circumferential surface of the bearing portion and an outer circumferential surface of the shaft, while a thrust dynamic pressure bearing portion arranged to generate a fluid dynamic pressure acting on the lubricating oil is defined in a thrust gap defined between the upper surface of the thrust plate and the annular surface of the bearing portion.

A bearing apparatus according to another preferred embodiment of the present invention includes a cylindrical bearing portion including an outer circumferential surface arranged to have a stator fixed thereto; a cap member arranged to close a bottom portion of the bearing portion; a shaft inserted in the bearing portion; and a thrust plate arranged to extend radially outward from a lower end portion of the shaft. The bearing portion includes a plate accommodating portion arranged to accommodate the thrust plate thereinside. An outer circumferential surface of the plate accommodating portion is arranged to have a diameter greater than a diameter of an outer circumferential surface of a portion of the bearing portion which is on an upper side of the plate accommodating portion, and a distance between the outer circumferential surface and an inner circumferential surface of the plate accommodating portion is arranged to be smaller than a distance between the outer circumferential surface and an inner circumferential surface of the portion of the bearing portion which is on the upper side of the plate accommodating portion. The bearing portion includes an annular surface arranged axially opposite an upper surface of the thrust plate. A radial dynamic pressure bearing portion arranged to generate a fluid dynamic pressure acting on a lubricating oil is defined in a radial gap defined between an inner circumferential surface of the bearing portion and an outer circumferential surface of the shaft, while a thrust dynamic pressure bearing portion arranged to generate a fluid dynamic pressure acting on the lubricating oil is defined in a thrust gap defined between the upper surface of the thrust plate and the annular surface of the bearing portion.

A bearing apparatus according to yet another preferred embodiment of the present invention includes a cylindrical bearing portion including an outer circumferential surface arranged to have a stator fixed thereto; a cap member arranged to close a bottom portion of the bearing portion; a holder arranged to hold a lower portion of the bearing portion on a lower side of the outer circumferential surface arranged to have the stator fixed thereto, the lower portion of the bearing portion including a plate accommodating portion; a shaft inserted in the bearing portion; and a thrust plate arranged to extend radially outward from a lower end portion of the shaft, and accommodated inside the plate accommodating portion. The bearing portion includes an annular surface arranged axially opposite an upper surface of the thrust plate. A radial dynamic pressure bearing portion arranged to generate a fluid dynamic pressure acting on a lubricating oil is defined in a radial gap defined between an inner circumferential surface of the bearing portion and an outer circumferential surface of the shaft, while a thrust dynamic pressure bearing portion arranged to generate a fluid dynamic pressure acting on the lubricating oil is defined in a thrust gap defined between the upper surface of the thrust plate and the annular surface of the bearing portion.

According to the present invention, it is possible to achieve improved bearing performance of a bearing apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of a fan according to a first preferred embodiment of the present invention.

FIG. 2 is a cross-sectional view illustrating a portion of a motor of the fan in an enlarged form.

FIG. 3 is a cross-sectional view illustrating a portion of the motor in an enlarged form.

FIG. 4 is a cross-sectional view illustrating a portion of the motor in an enlarged form.

FIG. 5 is a cross-sectional view of a sleeve of the motor.

FIG. 6 is a bottom view of the sleeve.

FIG. 7 is a plan view of a thrust cap of the motor.

FIG. 8 is a cross-sectional view of a motor according to a modification of the first preferred embodiment.

FIG. 9 is a cross-sectional view of a motor according to another modification of the first preferred embodiment.

FIG. 10 is a cross-sectional view of a fan according to a second preferred embodiment of the present invention.

FIG. 11 is a cross-sectional view illustrating a portion of a motor of the fan in an enlarged form.

FIG. 12 is a cross-sectional view of a motor according to a modification of the second preferred embodiment.

FIG. 13 is a cross-sectional view of a fan according to a third preferred embodiment of the present invention.

FIG. 14 is a cross-sectional view of a motor according to a modification of the third preferred embodiment.

FIG. 15 is a cross-sectional view of a fan according to a fourth preferred embodiment of the present invention.

FIG. 16 is a cross-sectional view of a motor according to a modification of the fourth preferred embodiment.

FIG. 17 is a cross-sectional view of a fan according to a fifth preferred embodiment of the present invention.

FIG. 18 is a cross-sectional view of a motor according to a modification of the fifth preferred embodiment.

FIG. 19 is a cross-sectional view of a fan according to a sixth preferred embodiment of the present invention.

FIG. 20 is a cross-sectional view of a motor according to a modification of the sixth preferred embodiment.

FIG. 21 is a cross-sectional view of a motor according to another modification of the fourth preferred embodiment.

### DETAILED DESCRIPTION OF THE PREFERRED EMBODIMENTS

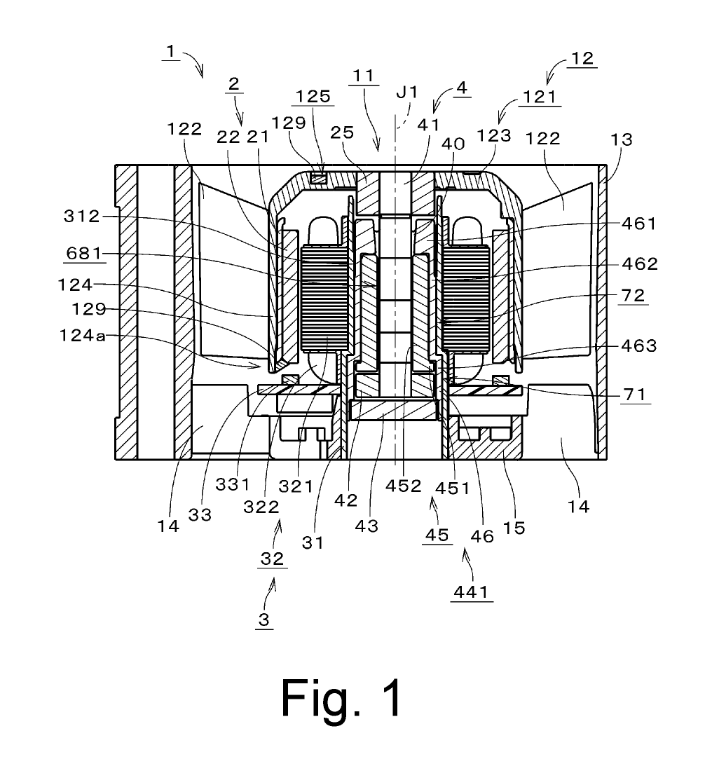

It is assumed herein that a vertical direction is defined as a direction in which a central axis of a motor extends, and that an upper side and a lower side along the central axis in FIG. 1 are referred to simply as an upper side and a lower side, respectively. It should be noted, however, that the above definitions of the vertical direction and the upper and lower sides should not be construed to restrict relative positions or directions of different members or portions when the motor is actually installed in a device. Also note that a direction parallel to the central axis is referred to by the term “axial direction”, “axial”, or “axially”, that radial directions centered on the central axis are simply referred to by the term “radial direction”, “radial”, or “radially”, and that a circumferential direction about the central axis is simply referred to by the term “circumferential direction”, “circumferential”, or “circumferentially”.

### First Preferred Embodiment

FIG. 1 is a cross-sectional view of an axial fan 1 according to a first preferred embodiment of the present invention. Hereinafter, the axial fan 1 will be referred to simply as the “fan 1”. The fan 1 is used as a cooling fan for an electronic device such as a server. The fan 1 includes a motor 11, an impeller 12, a housing 13, a plurality of support ribs 14, and a base portion 15. The housing 13 is arranged to surround an outer circumference of the impeller 12. The housing 13 is joined to the base portion 15 through the support ribs 14. The support ribs 14 are arranged in a circumferential direction. The base portion 15 and the support ribs 14 are defined integrally with each other, and are made of a resin. The motor 11 is fixed on the base portion 15.

The impeller 12 is made of a resin, and includes a cup 121 and a plurality of blades 122. The cup 121 is arranged substantially in the shape of a covered cylinder. The cup 121 is arranged to cover an outside of the motor 11. The cup 121 is arranged to define a portion of a rotating portion 2 of the motor 11. The rotating portion 2 will be described below. The cup 121 includes a top face portion 123 and a side wall portion 124. The top face portion 123 is an annular portion arranged to spread substantially perpendicularly to a central axis J1. The side wall portion 124 is a substantially cylindrical portion arranged to extend downward from an outer edge portion of the top face portion 123. The blades 122 are arranged to extend radially outward from an outer circumferential surface of the side wall portion 124 with the central axis J1 as a center. The blades 122 are arranged at regular intervals in the circumferential direction. The cup 121 and the blades 122 are defined as a single member by a resin injection molding process.

A hole portion 125 is defined in an upper surface of the top face portion 123. A weight 129 is arranged in the hole portion 125. The weight 129 is an adhesive including a metal having a high specific gravity, such as tungsten. Another weight 129 is arranged on a lower end portion 124a of the side wall portion 124 on a radially inner side thereof. A reduction in unbalance of each of the impeller 12 and the rotating portion 2 of the motor 11 can be achieved by arranging the weight 129 on each of an upper portion and a lower portion of the impeller 12. Two-plane balance correction as described above achieves a reduction in vibrations of the fan 1 owing to a displacement of a center of gravity of any of the impeller 12 and the motor 11 from the central axis J1. Hereinafter, the hole portion 125 and the lower end portion 124a of the side wall portion 124, on each of which the weight 129 is arranged, will be referred to as “balance correction portions 125 and 124a”, respectively. Note that, in the case where the rotating portion 2 has only a small amount of unbalance, balance correction may not necessarily be carried out. In other words, in the case where the rotating portion 2 has only a small amount of unbalance, the weight 129 may not necessarily be arranged on either of the balance correction portions 124a and 125. Alternatively, the weight 129 may be arranged on only one of the balance correction portions 124a and 125.

The impeller 12 of the fan 1 is caused by the motor 11 to rotate about the central axis J1 to produce a downward air current.

The motor 11 is a three-phase outer-rotor motor. The motor 11 includes the rotating portion 2, a stationary portion 3, and a bearing mechanism 4. The rotating portion 2 includes a substantially cylindrical metallic yoke 21, a rotor magnet 22, and the cup 121. The yoke 21 is fixed to an inside of the cup 121. The rotor magnet 22 is fixed to an inner circumferential surface of the yoke 21. Note that the yoke 21, which is a magnetic body, and the cup 121, which is made of the resin, may be defined integrally with each other by an insert molding process. The rotating portion 2 is supported through the bearing mechanism 4 to be rotatable about the central axis J1 with respect to the stationary portion 3.

The stationary portion 3 includes a stator 32 and a circuit board 33. The stator 32 is arranged radially inside the rotor magnet 22. The stator 32 includes a stator core 321 and a plurality of coils 322 arranged on the stator core 321. The stator core 321 is defined by laminated steel sheets.

The circuit board 33 is arranged below the stator 32. Lead wires from the coils 322 are attached to pins (not shown) inserted in holes of the circuit board 33, whereby the stator 32 and the circuit board 33 are electrically connected with each other. Note that the lead wires from the coils 322 may be directly connected to the circuit board 33. During drive of the motor 11, a turning force is generated between the rotor magnet 22 and the stator 32.

An annular magnetic member 331 is arranged on an upper surface of the circuit board 33. The magnetic member 331 is arranged under the rotor magnet 22. While the motor 11 is stationary, a magnetic center of the stator 32 is located at a level lower than that of a magnetic center of the rotor magnet 22. In the fan 1, magnetic attraction forces that attract the rotor magnet 22 downward are generated between the rotor magnet 22 and the stator 32, and between the rotor magnet 22 and the magnetic member 331. The extent to which the impeller 12 is lifted relative to the stationary portion 3 during rotation of the fan 1 is thereby reduced.

The bearing mechanism 4 is a bearing apparatus arranged to generate a fluid dynamic pressure acting on a lubricating oil 40, which will be described below. The bearing mechanism 4 includes a holder 31, a shaft 41, an annular thrust plate 42, a thrust cap 43, i.e., a cap member, a bearing portion 441, a bushing 25, and the lubricating oil 40. Note that each of the shaft 41, the thrust plate 42, and the bushing 25 may be considered as a portion of the rotating portion 2. Also note that each of the holder 31, the bearing portion 441, and the thrust cap 43 may be considered as a portion of the stationary portion 3. The same is true of other preferred embodiments of the present invention described below.

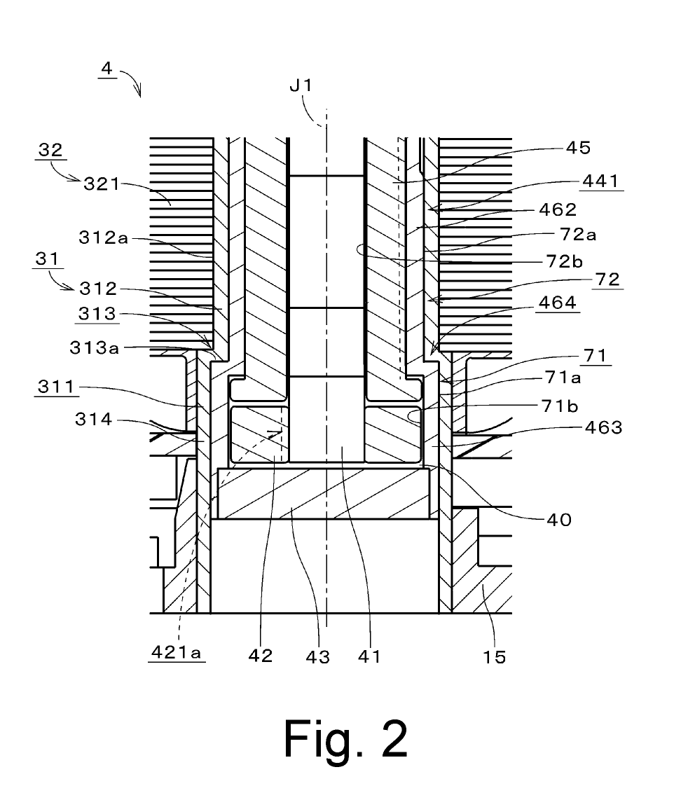

FIG. 2 is a cross-sectional view illustrating a lower portion of the bearing mechanism 4 and its vicinity in an enlarged form. The holder 31 is a metallic member arranged substantially in the shape of a cylinder centered on the central axis J1, and is arranged to hold the bearing portion 441 thereinside. A lower portion of the holder 31 is fixed to a central hole portion of the base portion 15. Note that the holder 31, which is made of a metal, and the base portion 15, which is made of the resin, may be defined integrally with each other by an insert molding process. The holder 31 includes an increased diameter portion 311 and a stator fixing portion 312. The increased diameter portion 311 is arranged on a lower side of the stator fixing portion 312. The increased diameter portion 311 is arranged to have an outside diameter greater than the diameter of an outer circumferential surface 312a of the stator fixing portion 312. The increased diameter portion 311 includes an annular portion 313 and a lower tubular portion 314. The annular portion 313 is arranged in a substantially annular shape centered on the central axis J1, and is arranged to extend radially outward from a bottom portion of the outer circumferential surface 312a of the stator fixing portion 312. The lower tubular portion 314 is arranged in the shape of a cylinder centered on the central axis J1, and is arranged to extend downward from the annular portion 313. The stator core 321 is arranged on an upper side of the increased diameter portion 311. A radially inner portion of the stator core 321 is fixed to the outer circumferential surface 312a of the stator fixing portion 312. In addition, the radially inner portion of the stator core 321 is arranged to be in axial contact with an upper surface 313a of the annular portion 313, i.e., a surface having a normal oriented upward.

The bushing 25 illustrated in FIG. 1 is arranged in a substantially annular shape centered on the central axis J1, and is made of a metal. An upper portion of the shaft 41 is fixed to the bushing 25 on an upper side of the bearing portion 441. The top face portion 123 of the impeller 12 is attached to an outer circumferential surface of the bushing 25. The bushing 25 is arranged to have an outside diameter smaller than the inside diameter of the stator fixing portion 312. The thrust plate 42 is arranged to extend radially outward from a lower end portion of the shaft 41. As illustrated in FIG. 2, a communicating hole 421a extending in an axial direction is defined between the thrust plate 42 and the shaft 41. The thrust cap 43 is arranged to close a bottom portion of the bearing portion 441 below the thrust plate 42.

As illustrated in FIG. 1, the bearing portion 441 includes a tubular sleeve 45 and a substantially cylindrical bearing housing 46 arranged to cover an outer circumferential surface of the sleeve 45. The sleeve 45 is a metallic sintered body, and is impregnated with the lubricating oil 40. The shaft 41 is inserted in the sleeve 45. A lower surface of the sleeve 45 is an annular surface extending perpendicularly to the central axis J1, and is arranged axially opposite an upper surface of the thrust plate 42. A bottom portion 451 of the sleeve 45 is arranged to project radially outward, and the bottom portion 451 is arranged to have an outside diameter greater than the outside diameter of a portion 452 of the sleeve 45 which is on an upper side of the bottom portion 451. Hereinafter, the bottom portion 451 will be referred to as a “sleeve bottom portion 451”, and the portion 452 will be referred to as a “sleeve upper portion 452”. The thrust plate 42 is arranged to have an outside diameter greater than the outside diameter of the sleeve upper portion 452.

The bearing housing 46 includes an annular upper portion 461, a sleeve holding portion 462, and a housing lower portion 463. The annular upper portion 461 is a substantially annular portion arranged to extend radially on an upper side of the sleeve 45. The sleeve holding portion 462 is arranged substantially in the shape of a cylinder, arranged to extend downward from an outer edge portion of the annular upper portion 461, and is arranged to hold the sleeve upper portion 452. The housing lower portion 463, which is a lower portion of the bearing housing 46 and is arranged substantially in the shape of a cylinder, is arranged to extend downwardly of the sleeve 45 on a lower side of the sleeve holding portion 462. The housing lower portion 463 is arranged to cover an outer circumferential surface of the thrust plate 42.

In the bearing portion 441, the housing lower portion 463 and the sleeve bottom portion 451 are arranged to together define a plate accommodating portion 71 arranged to accommodate the thrust plate 42 thereinside. Hereinafter, the sleeve holding portion 462 and the sleeve upper portion 452, i.e., a portion of the bearing portion 441 which is on an upper side of the plate accommodating portion 71, will be referred to collectively as a “bearing middle portion 72”.

As illustrated in FIG. 2, the plate accommodating portion 71 is arranged radially inside the lower tubular portion 314 of the holder 31. A shoulder portion 464, which is defined by an increase in the diameter of the bearing housing 46, is defined between the sleeve holding portion 462 and the housing lower portion 463. The shoulder portion 464 and the annular portion 313 of the holder 31 are arranged to be in axial contact with each other.

An inner circumferential surface 71b of the plate accommodating portion 71, i.e., an inner circumferential surface of the housing lower portion 463, is arranged to have a diameter greater than the diameter of an inner circumferential surface of the sleeve holding portion 462. An outer circumferential surface 71a of the plate accommodating portion 71, i.e., an outer circumferential surface of the housing lower portion 463, is arranged to have a diameter greater than the diameter of an outer circumferential surface 72a of the bearing middle portion 72, i.e., an outer circumferential surface of the sleeve holding portion 462. The distance between the outer circumferential surface 71a and the inner circumferential surface 71b of the plate accommodating portion 71 is arranged to be smaller than the distance between the outer circumferential surface 72a of the bearing middle portion 72 and an inner circumferential surface 72b of the bearing middle portion 72, i.e., an inner circumferential surface of the sleeve 45.

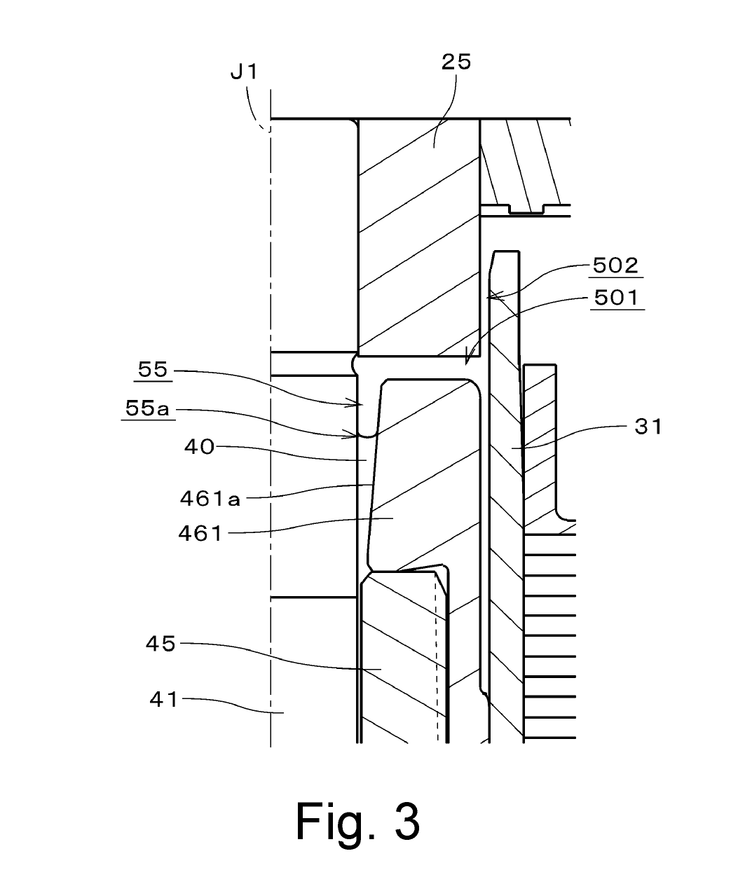

Referring to FIG. 3, an inner circumferential surface 461a of the annular upper portion 461 is arranged to be inclined radially inward with decreasing height. A single seal gap 55 arranged to gradually increase in radial width with increasing height is defined between the inner circumferential surface 461a of the annular upper portion 461 and an outer circumferential surface of the shaft 41. The seal gap 55 is arranged in an annular shape centered on the central axis J1. The seal gap 55 includes a seal portion 55a arranged to retain the lubricating oil 40 through capillary action. A surface of the lubricating oil 40 is defined in the seal gap 55. The seal gap 55 serves as an oil buffer arranged to hold a large amount of the lubricating oil 40 as well.

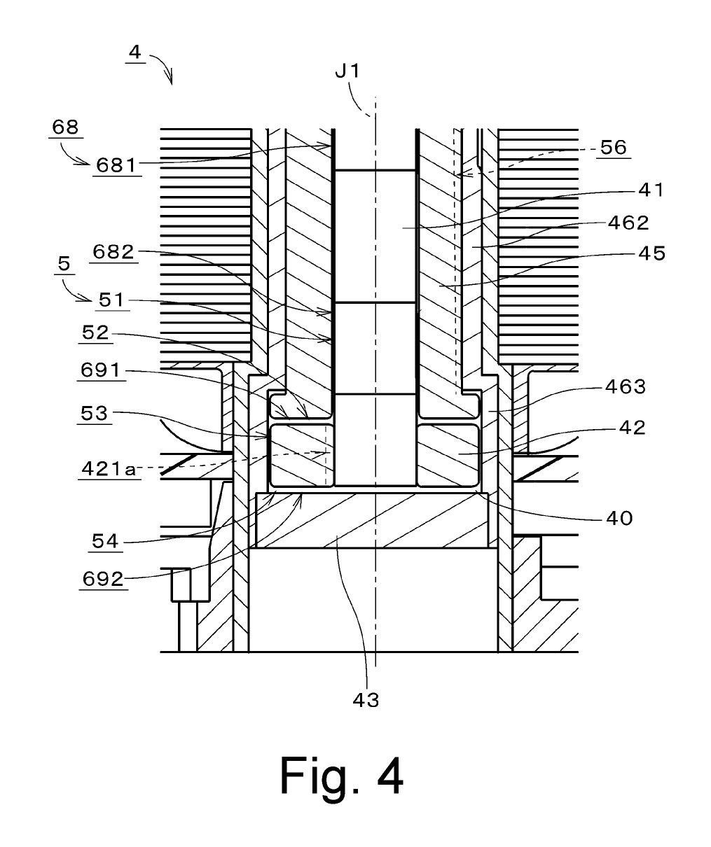

Referring to FIG. 4, a radial gap 51 is defined between the inner circumferential surface of the sleeve 45 and the outer circumferential surface of the shaft 41. The radial gap 51 is arranged on a lower side of the seal gap 55 illustrated in FIG. 3. The outer circumferential surface of the sleeve 45 includes a vertical groove extending in the axial direction defined therein. A surface which defines this vertical groove and the inner circumferential surface of the sleeve holding portion 462 are arranged to together define a circulation hole 56 therebetween. A gap 52 is defined between the upper surface of the thrust plate 42 and the lower surface of the sleeve 45. Hereinafter, the gap 52 will be referred to as a “first thrust gap 52”. A gap 54 is defined between a lower surface of the thrust plate 42 and an upper surface of the thrust cap 43. Hereinafter, the gap 54 will be referred to as a “second thrust gap 54”. The sum of the axial width of the first thrust gap 52 and the axial width of the second thrust gap 54 is arranged in the range of about 10 μm to about 40 μm. A gap 53 is defined between the outer circumferential surface of the thrust plate 42 and the inner circumferential surface of the housing lower portion 463. Hereinafter, the gap 53 will be referred to as a “side gap 53”.

In the motor 11, the seal gap 55 illustrated in FIG. 3, the radial gap 51, the first thrust gap 52, the side gap 53, and the second thrust gap 54 are arranged to together define a single continuous bladder structure 5, and the lubricating oil 40 is arranged continuously in the bladder structure 5. Within the bladder structure 5, the surface of the lubricating oil 40 is defined only in the seal gap 55.

During the drive of the motor 11, the lubricating oil 40 is arranged to circulate through a channel made up of the radial gap 51, the first thrust gap 52, the circulation hole 56, and a gap defined between a lower surface of the annular upper portion 461 and an upper surface of the sleeve 45 illustrated in FIG. 3. Moreover, the lubricating oil 40 is also arranged to circulate through a channel made up of the first thrust gap 52, the side gap 53, the second thrust gap 54, and the communicating hole 421a.

Referring to FIG. 3, an upper surface of the annular upper portion 461 and a lower surface of the bushing 25, which is fixed to the upper portion of the shaft 41, are arranged to together define a horizontal gap 501 extending in directions perpendicular to the central axis J1 therebetween. The outer circumferential surface of the bushing 25 and an upper portion of an inner circumferential surface of the holder 31 are arranged to together define a vertical gap 502 extending in the axial direction therebetween. Each of the axial width of the horizontal gap 501 and the radial width of the vertical gap 502 is arranged to be 200 μm or less, and more preferably 100 μm or less. The seal gap 55 is arranged to be in communication with an exterior space through the horizontal gap 501 and the vertical gap 502. Here, the exterior space refers to a space above the stator 32 as illustrated in FIG. 1. Provision of the horizontal gap 501 and the vertical gap 502 contributes to preventing an air including a lubricating oil evaporated from the seal portion 55a from traveling out of the bearing mechanism 4. This contributes to reducing evaporation of the lubricating oil 40 out of the bearing mechanism 4.

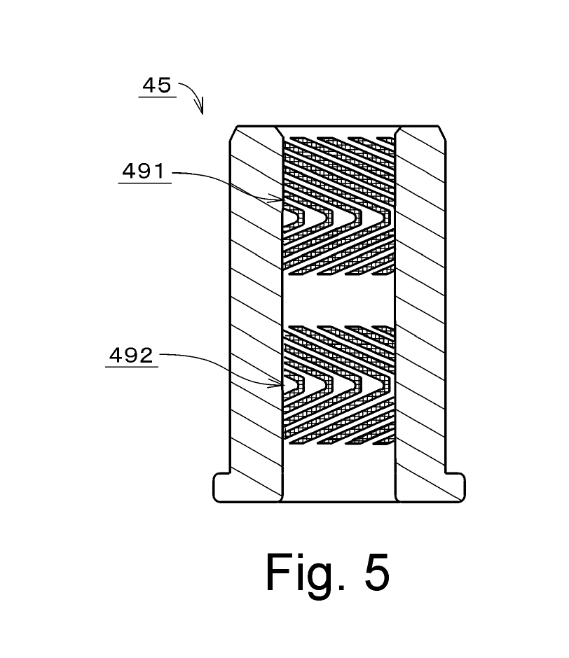

FIG. 5 is a vertical cross-sectional view of the sleeve 45. An upper portion and a lower portion of the inner circumferential surface of the sleeve 45 include a first radial dynamic pressure groove array 491 and a second radial dynamic pressure groove array 492, respectively, defined therein. Each of the first and second radial dynamic pressure groove arrays 491 and 492 is arranged in a herringbone pattern. In an upper portion of the radial gap 51 illustrated in FIG. 4, an upper radial dynamic pressure bearing portion 681 arranged to generate a fluid dynamic pressure acting in a radial direction on the lubricating oil 40 is defined through the first radial dynamic pressure groove array 491. In a lower portion of the radial gap 51, a lower radial dynamic pressure bearing portion 682 is defined through the second radial dynamic pressure groove array 492. Hereinafter, the upper and lower radial dynamic pressure bearing portions 681 and 682 will be referred to collectively as a “radial dynamic pressure bearing portion 68”. The radial dynamic pressure bearing portion 68 is arranged axially between the two balance correction portions 124a and 125 illustrated in FIG. 1. In addition, the upper radial dynamic pressure bearing portion 681 is arranged to overlap with a center of gravity of a combination of the impeller 12 and the rotating portion 2 of the motor 11 in the radial direction.

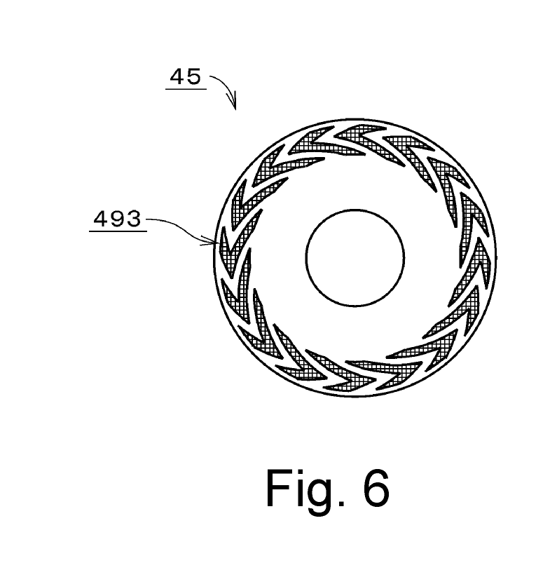

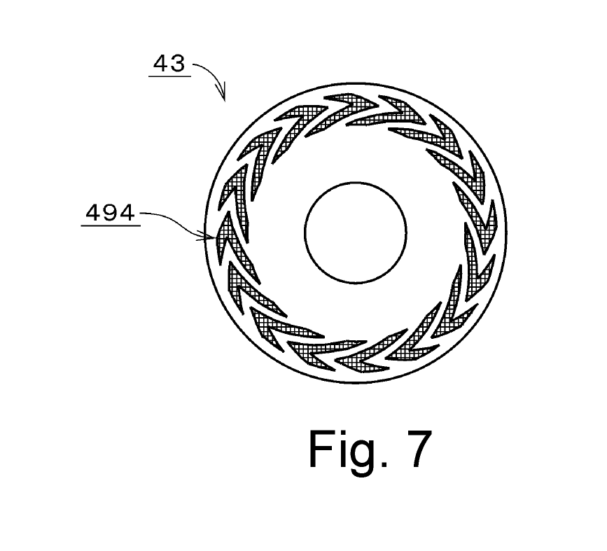

FIG. 6 is a bottom view of the sleeve 45. The lower surface of the sleeve 45 includes a first thrust dynamic pressure groove array 493 arranged in a herringbone pattern defined therein. FIG. 7 is a plan view of the thrust cap 43. The upper surface of the thrust cap 43 includes a second thrust dynamic pressure groove array 494 arranged in a herringbone pattern defined therein. In the first thrust gap 52 illustrated in FIG. 4, a first thrust dynamic pressure bearing portion 691 arranged to generate a fluid dynamic pressure acting in the axial direction on the lubricating oil 40 is defined through the first thrust dynamic pressure groove array 493. In addition, in the second thrust gap 54, a second thrust dynamic pressure bearing portion 692 is defined through the second thrust dynamic pressure groove array 494.

During the drive of the motor 11, the shaft 41 is supported in the radial direction by the radial dynamic pressure bearing portion 68, while the thrust plate 42, which is arranged above a bottom portion of the bladder structure 5, is supported in a thrust direction by the first and second thrust dynamic pressure bearing portions 691 and 692. As a result, the rotating portion 2 and the impeller 12 illustrated in FIG. 1 are supported to be rotatable with respect to the stationary portion 3.

The fan 1 according to the first preferred embodiment has been described above. In the bearing mechanism 4, the outer circumferential surface 71a of the plate accommodating portion 71 is arranged radially outward of the outer circumferential surface 72a of the bearing middle portion 72, and the distance between the inner circumferential surface 71b and the outer circumferential surface 71a of the plate accommodating portion 71 is arranged to be smaller than the distance between the inner circumferential surface 72b and the outer circumferential surface 72a of the bearing middle portion 72. An increase in the radial dimension of a space inside the plate accommodating portion 71 is thus achieved, making it possible to increase the outside diameter of the thrust plate 42, which is accommodated in the plate accommodating portion 71. In particular, an additional increase in the outside diameter of the thrust plate 42 is achieved by arranging the outside diameter of the bearing middle portion 72 to be substantially equal to the inside diameter of the plate accommodating portion 71.

The above arrangements make it possible to define the first and second thrust dynamic pressure bearing portions 691 and 692 in the first and second thrust gaps 52 and 54, respectively, such that each of the first and second thrust dynamic pressure bearing portions 691 and 692 is capable of generating a sufficient fluid dynamic pressure, so that an improvement in bearing performance of the bearing mechanism 4 can be achieved. The improvement in the bearing performance of the bearing mechanism 4 enables the bearing mechanism 4 to sufficiently support the impeller and the rotating portion even when the fan has a large size. In addition, the fan 1 is allowed to rotate at a higher speed to increase the volume of an air which is sent out from the fan 1. This enables the fan 1 to cool the electronic device with increased efficiency. A radially outward projection of only the sleeve bottom portion 451 of the sleeve 45 achieves an increase in the size of the surface which is axially opposed to the thrust plate 42 without increasing the size of the entire sleeve 45.

Because the outside diameter of the bushing 25 is arranged to be smaller than the inside diameter of the stator fixing portion 312 of the holder 31, it is possible to define the horizontal gap 501 and the vertical gap 502 by fixing the bushing 25, to which the impeller can be attached, to the upper portion of the shaft 41 when the bearing mechanism 4 is assembled, and dust is prevented from entering into the bearing mechanism 4 when the bearing mechanism 4 and another member of the fan 1 are attached to each other.

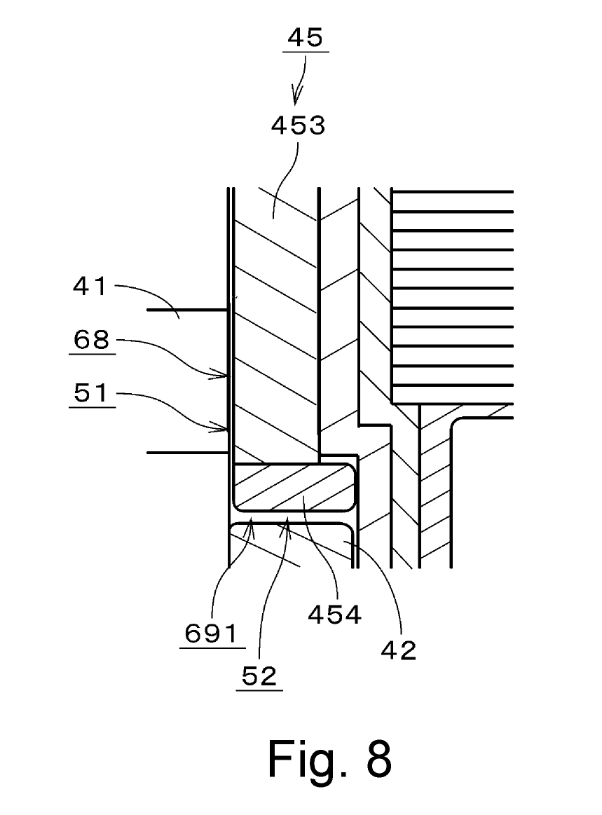

Referring to FIG. 8, the sleeve 45 may be defined by two members in the bearing mechanism 4. In this case, the sleeve 45 includes an upper sleeve 453 and a lower sleeve 454. In the sleeve 45, the upper sleeve 453 is a member corresponding to the sleeve upper portion 452 of the sleeve 45 illustrated in FIG. 1, and the lower sleeve 454 is a member corresponding to the sleeve bottom portion 451 of the sleeve 45 illustrated in FIG. 1. The radial dynamic pressure bearing portion 68 is defined in a radial gap 51 defined between an inner circumferential surface of the upper sleeve 453 and the outer circumferential surface of the shaft 41. The lower sleeve 454 is fixed to a bottom portion of the upper sleeve 453. The lower sleeve 454 is arranged to have an outside diameter greater than the outside diameter of the upper sleeve 453. The thrust plate 42 is arranged to have an outside diameter greater than the outside diameter of the upper sleeve 453. The first thrust dynamic pressure bearing portion 691 is defined in a thrust gap 52 defined between a lower surface of the lower sleeve 454 and the upper surface of the thrust plate 42. The sleeve 45 being defined by the two members makes it easier to define the sleeve 45.

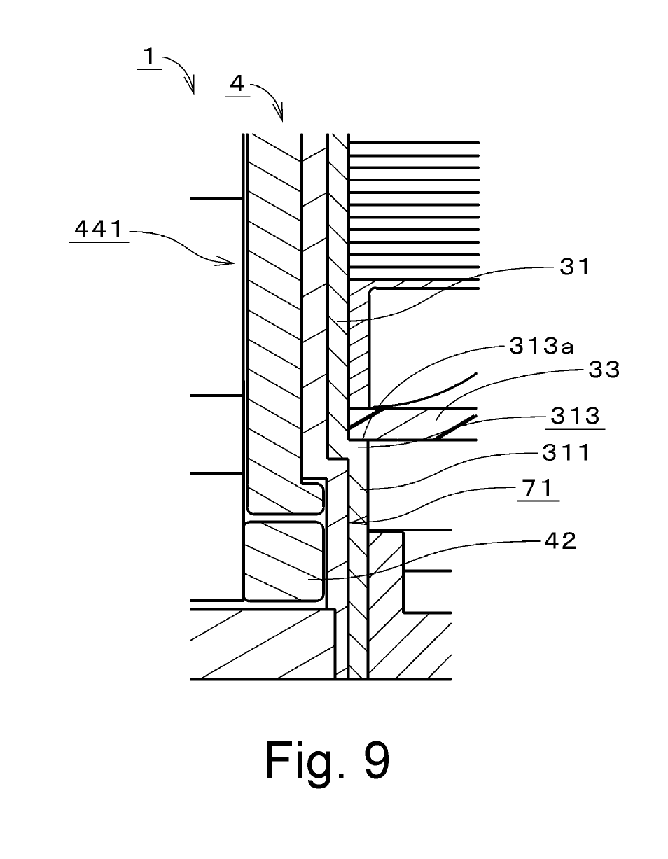

FIG. 9 is a diagram illustrating a bearing mechanism 4 according to a modification of the first preferred embodiment. Each of an increased diameter portion 311 of a holder 31 and a plate accommodating portion 71 of a bearing portion 441 is arranged below a circuit board 33. A radially inner portion of the circuit board 33 is arranged to be in axial contact with an upper surface 313a of an annular portion 313 of the increased diameter portion 311. The bearing mechanism 4 according to the present modification of the first preferred embodiment is otherwise similar in structure to the bearing mechanism 4 illustrated in FIG. 2. Since the number of members of a fan 1 which are arranged below the circuit board 33 is small, it is relatively easy to design the fan 1 such that the plate accommodating portion 71 is expanded radially outward according to the present modification of the first preferred embodiment. Such a design makes it possible to further increase the outside diameter of a thrust plate 42.

### Second Preferred Embodiment

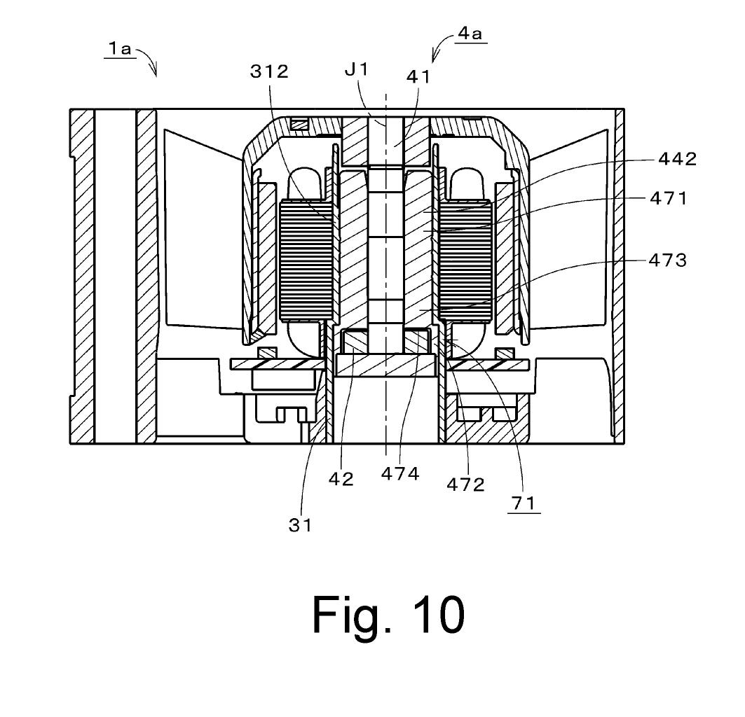

FIG. 10 is a diagram illustrating a fan 1a according to a second preferred embodiment of the present invention. A bearing mechanism 4a includes a bearing portion 442, which is a single sleeve made of a metal such as stainless steel or phosphor bronze. The bearing portion 442 is fixed to an inner circumferential surface of a stator fixing portion 312 of a holder 31. The bearing portion 442 includes a bearing upper portion 471 and a bearing lower portion 472. A shaft 41 is inserted in the bearing upper portion 471. A lower surface 474 of a lower end portion 473 of the bearing upper portion 471, i.e., a surface having a normal oriented downward, is arranged in an annular shape centered on a central axis J1, and is arranged axially opposite an upper surface of a thrust plate 42. The bearing lower portion 472 is arranged substantially in the shape of a cylinder centered on the central axis J1, and is arranged to extend downward from the bearing upper portion 471. The bearing lower portion 472 is arranged to cover an outer circumferential surface of the thrust plate 42. In the bearing mechanism 4a, the lower end portion 473 of the bearing upper portion 471 and the bearing lower portion 472 are arranged to together define a plate accommodating portion 71 arranged to accommodate the thrust plate 42 thereinside.

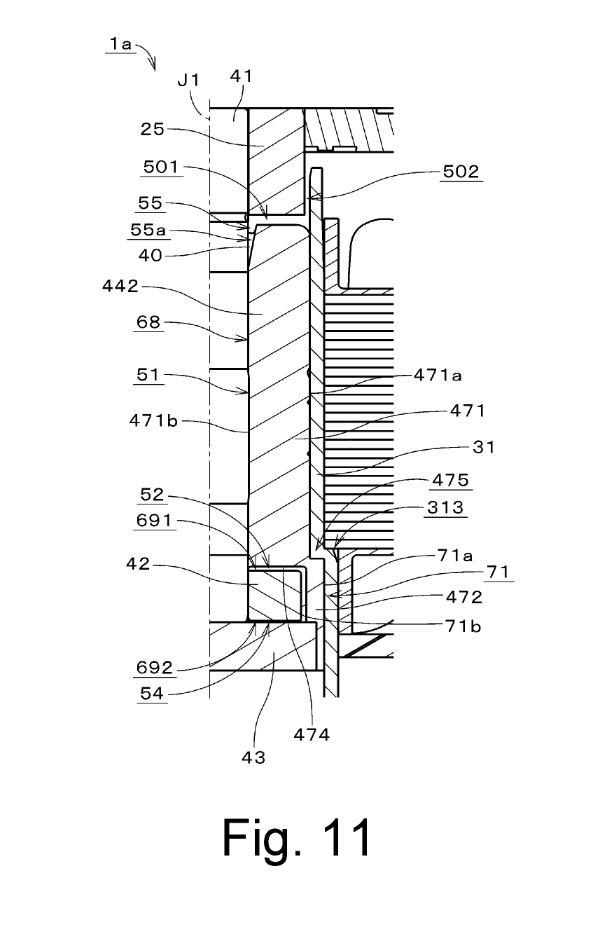

Referring to FIG. 11, an inner circumferential surface 71b of the plate accommodating portion 71, i.e., an inner circumferential surface of the bearing lower portion 472, is arranged to have a diameter greater than the diameter of an inner circumferential surface 471b of the bearing upper portion 471. An outer circumferential surface 71a of the plate accommodating portion 71, i.e., an outer circumferential surface of the bearing lower portion 472, is arranged to have a diameter greater than the diameter of an outer circumferential surface 471a of the bearing upper portion 471, which is a portion of the bearing portion 442 which is on an upper side of the plate accommodating portion 71. The distance between the outer circumferential surface 71a and the inner circumferential surface 71b of the plate accommodating portion 71 is arranged to be smaller than the distance between the outer circumferential surface 471a and the inner circumferential surface 471b of the bearing upper portion 471. A shoulder portion 475, which is defined by an increase in the diameter of the bearing portion 442, is defined between the bearing upper portion 471 and the bearing lower portion 472. An upper surface of the shoulder portion 475 is arranged to be in axial contact with an annular portion 313 of the holder 31. The fan 1a is otherwise similar in structure to the fan 1 according to the first preferred embodiment.

The lower surface 474 of the bearing upper portion 471 includes a first thrust dynamic pressure groove array 493 similar to the first thrust dynamic pressure groove array 493 illustrated in FIG. 6 defined therein. A first thrust dynamic pressure bearing portion 691 arranged to support the thrust plate 42 in an axial direction is defined in a first thrust gap 52 defined between the lower surface 474 and the upper surface of the thrust plate 42. In addition, an upper surface of a thrust cap 43 includes a second thrust dynamic pressure groove array 494 similar to the second thrust dynamic pressure groove array 494 illustrated in FIG. 7 defined therein. A second thrust dynamic pressure bearing portion 692 is defined in a second thrust gap 54 defined between the thrust cap 43 and the thrust plate 42.

An inner circumferential surface of the bearing portion 442 includes a first radial dynamic pressure groove array 491 and a second radial dynamic pressure groove array 492 defined therein in a manner similar to that illustrated in FIG. 5. A radial dynamic pressure bearing portion 68 arranged to support the shaft 41 in a radial direction is defined in a radial gap 51 defined between the inner circumferential surface of the bearing portion 442 and an outer circumferential surface of the shaft 41. On an upper side of the radial gap 51, a seal gap 55 arranged to have a surface of a lubricating oil 40 defined therein is defined between an upper portion of the inner circumferential surface of the bearing portion 442 and the outer circumferential surface of the shaft 41. A seal portion 55a arranged to retain the lubricating oil 40 is defined in the seal gap 55. A bushing 25 is fixed to an upper portion of the shaft 41, and a horizontal gap 501 is defined between a lower surface of the bushing 25 and an upper surface of the bearing portion 442. A vertical gap 502 is defined between an outer circumferential surface of the bushing 25 and an upper portion of an inner circumferential surface of the holder 31. Provision of the horizontal gap 501 and the vertical gap 502 contributes to reducing evaporation of the lubricating oil 40 out of the seal portion 55a.

Also in the second preferred embodiment, an increase in the radial dimension of a space inside the plate accommodating portion 71 can be achieved, enabling the thrust plate 42 arranged therein to have a large outside diameter. This makes it possible to define the first and second thrust dynamic pressure bearing portions 691 and 692 such that each of the first and second thrust dynamic pressure bearing portions 691 and 692 is capable of generating a sufficient fluid dynamic pressure.

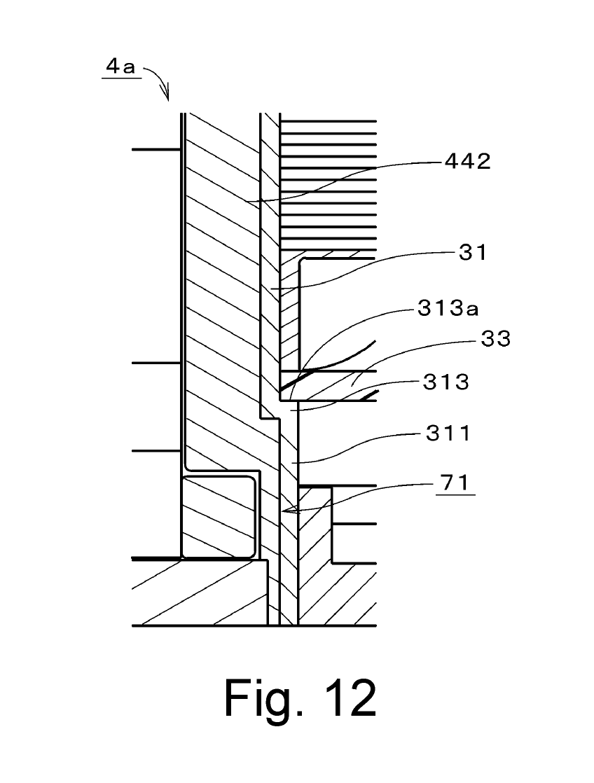

FIG. 12 is a diagram illustrating a bearing mechanism 4a according to a modification of the second preferred embodiment. A radially inner portion of a circuit board 33 is arranged to be in axial contact with an upper surface 313a of an annular portion 313 of an increased diameter portion 311 of a holder 31. Each of the increased diameter portion 311 and a plate accommodating portion 71 of a bearing portion 442 is arranged on a lower side of the circuit board 33. Since the plate accommodating portion 71 is arranged on the lower side of the circuit board 33, it is easy to design a fan 1a such that the plate accommodating portion 71 is expanded radially outward.

### Third Preferred Embodiment

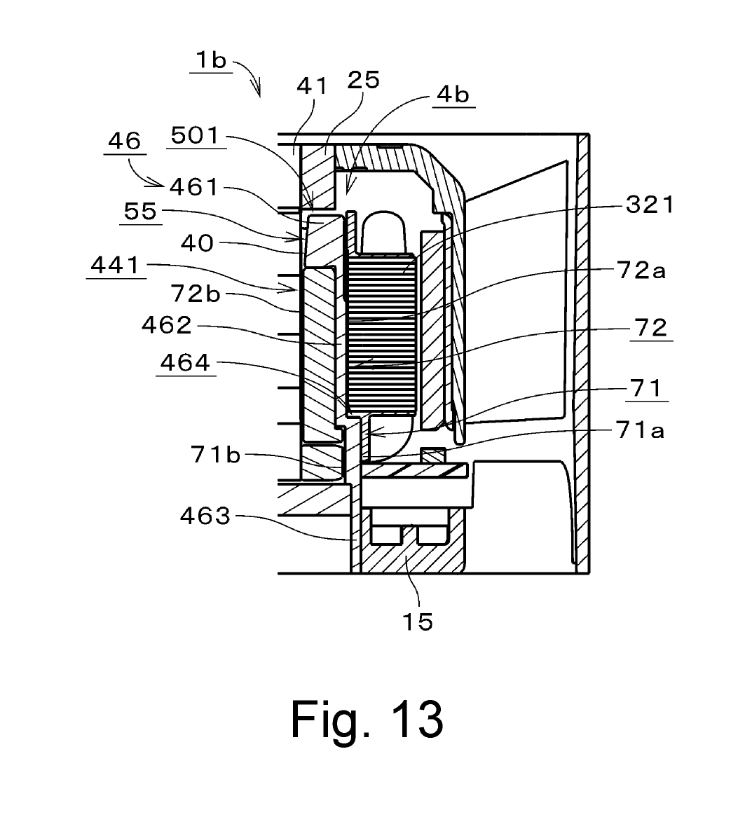

FIG. 13 is a diagram illustrating a fan 1b according to a third preferred embodiment of the present invention. A bearing mechanism 4b of the fan 1b includes a bearing portion 441 having a structure similar to that of the bearing portion 441 of the fan 1 according to the first preferred embodiment. The fan 1b does not include the holder 31 illustrated in FIG. 1, and a stator core 321 is directly fixed to an outer circumferential surface 72a of a bearing middle portion 72. The stator core 321 is arranged on an upper side of a plate accommodating portion 71. A radially inner portion of the stator core 321 is arranged to be in axial contact with a shoulder portion 464 defined between a housing lower portion 463 and a sleeve holding portion 462 of a bearing housing 46. The housing lower portion 463 is fixed to a hole portion of a base portion 15. The fan 1b is otherwise similar in structure to the fan 1 according to the first preferred embodiment.

A bushing 25 is fixed to an upper portion of a shaft 41. A radially extending horizontal gap 501 is defined between a lower surface of the bushing 25 and an upper surface of an annular upper portion 461 of the bearing housing 46. A seal gap 55 is arranged to be in communication with an exterior space through the horizontal gap 501. The bushing 25 is arranged to have an outside diameter smaller than the inside diameter of the stator core 321. This enables the horizontal gap 501 to be defined between the annular upper portion 461 and the bushing 25, to which an impeller can be attached, when the bearing mechanism 4b is assembled, and dust is prevented from entering into the bearing mechanism 4b when the bearing mechanism 4b and another member of the fan 1b are attached to each other. The same is true of other preferred embodiments of the present invention described below. Moreover, when the horizontal gap 501 is arranged to have a small axial width, evaporation of a lubricating oil 40 out of the seal gap 55 can be reduced to some extent.

Also in the third preferred embodiment, an outer circumferential surface 71a of the plate accommodating portion 71 is arranged to have a diameter greater than the diameter of the outer circumferential surface 72a of the bearing middle portion 72, and the distance between the outer circumferential surface 71a and an inner circumferential surface 71b of the plate accommodating portion 71 is arranged to be smaller than the distance between the outer circumferential surface 72a and an inner circumferential surface 72b of the bearing middle portion 72. An increase in the radial dimension of a space inside the plate accommodating portion 71 can thereby be achieved. Since the fan 1b does not include the holder, it is possible to increase the radial dimension of the entire bearing housing 46 by the thickness of the holder. This enables an additional increase in the radial dimension of the space inside the plate accommodating portion 71.

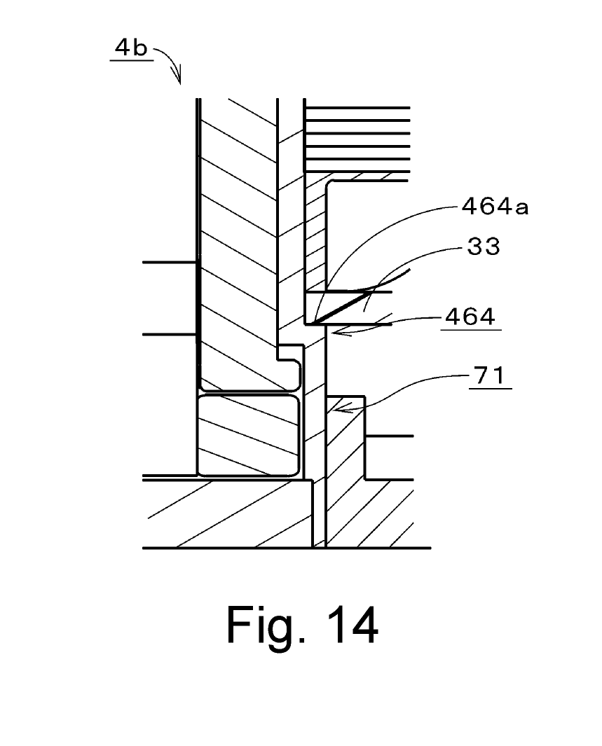

FIG. 14 is a diagram illustrating a bearing mechanism 4b according to a modification of the third preferred embodiment. A plate accommodating portion 71 is arranged on a lower side of a circuit board 33. A radially inner portion of the circuit board 33 is arranged to be in axial contact with an upper surface 464a of a shoulder portion 464, which is arranged on an upper side of the plate accommodating portion 71. Also in the case of FIG. 14, it is easy to design a fan 1b such that the plate accommodating portion 71 is expanded radially outward.

### Fourth Preferred Embodiment

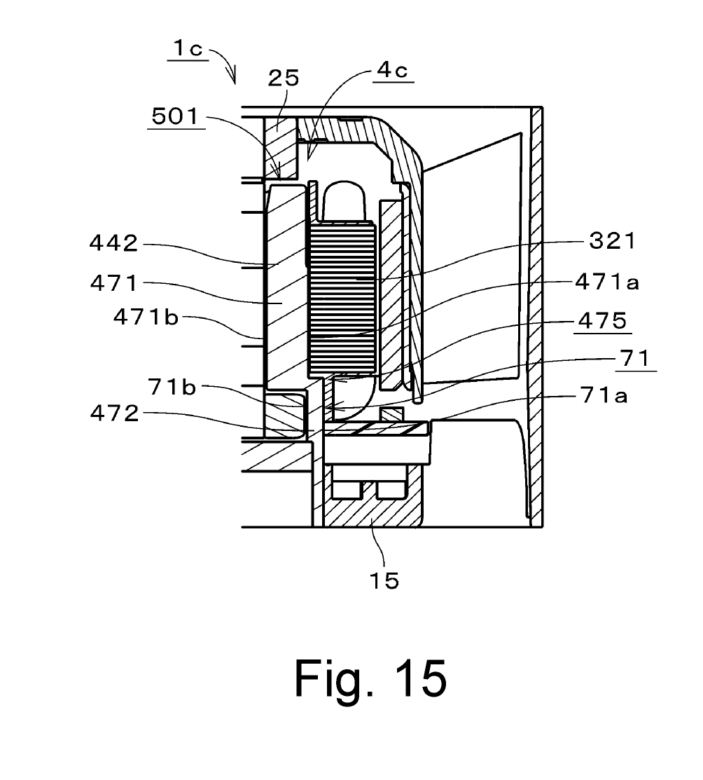

FIG. 15 is a diagram illustrating a fan 1c according to a fourth preferred embodiment of the present invention. A bearing mechanism 4c of the fan 1c includes a bearing portion 442 which is similar in shape to the bearing portion 442 of the fan 1a according to the second preferred embodiment. The fan 1c does not include the holder, and a stator core 321 is directly fixed to an outer circumferential surface 471a of a bearing upper portion 471. A radially inner portion of the stator core 321 is arranged to be in axial contact with an upper surface of a shoulder portion 475 defined between the bearing upper portion 471 and a bearing lower portion 472. The bearing lower portion 472 is fixed to a hole portion of a base portion 15. A horizontal gap 501 is defined between an upper surface of the bearing portion 442 and a lower surface of a bushing 25. The fan 1c is otherwise similar in structure to the fan 1a according to the second preferred embodiment.

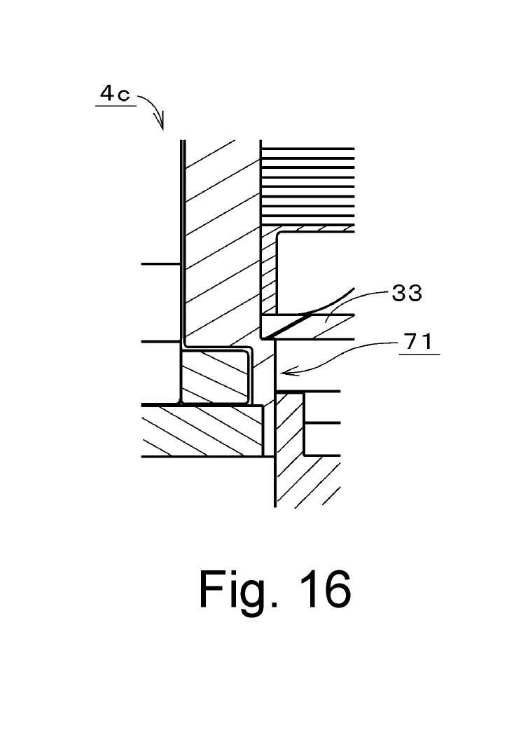

In the fourth preferred embodiment, as well as in the second preferred embodiment, an outer circumferential surface 71a of a plate accommodating portion 71 is arranged to have a diameter greater than the diameter of the outer circumferential surface 471a of the bearing upper portion 471, and the distance between the outer circumferential surface 71a and an inner circumferential surface 71b of the plate accommodating portion 71 is arranged to be smaller than the distance between the outer circumferential surface 471a and an inner circumferential surface 471b of the bearing upper portion 471. An increase in the radial dimension of a space inside the plate accommodating portion 71 can thereby be achieved. Since the fan 1c does not include the holder, an additional increase in the radial dimension of the space inside the plate accommodating portion 71 can be achieved. Referring to FIG. 16, in a modification of the bearing mechanism 4c, the plate accommodating portion 71 may be arranged on a lower side of a circuit board 33, and arranged to be in axial contact with the circuit board 33 in a manner similar to that illustrated in FIG. 14.

### Fifth Preferred Embodiment

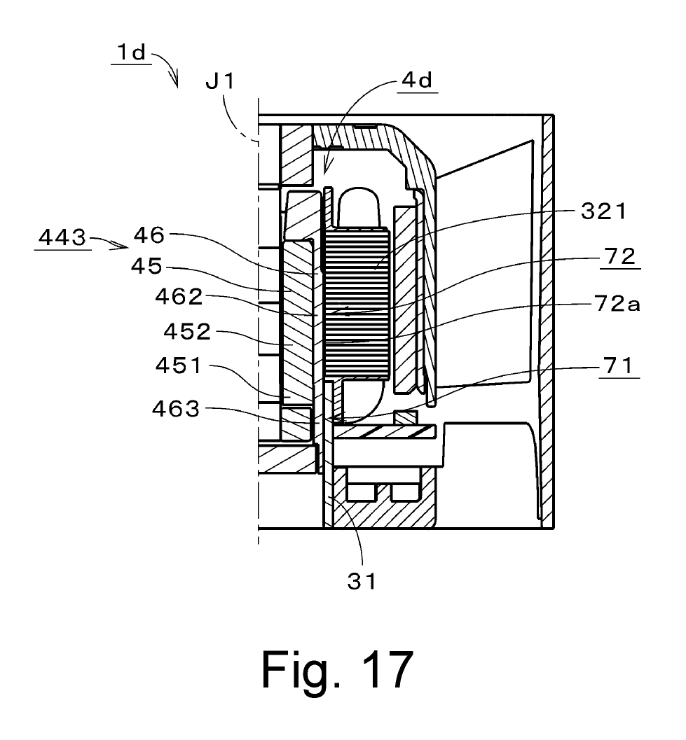

FIG. 17 is a cross-sectional view of a fan 1d according to a fifth preferred embodiment of the present invention. In a bearing portion 443 of a bearing mechanism 4d of the fan 1d, an inner circumferential surface and an outer circumferential surface of a sleeve holding portion 462 of a bearing housing 46 are arranged to have diameters substantially equal to the diameters of an inner circumferential surface and an outer circumferential surface of a housing lower portion 463, respectively. A sleeve 45 is arranged in the shape of a cylinder centered on a central axis J1. A sleeve bottom portion 451 is arranged to have an outside diameter equal to the outside diameter of a sleeve upper portion 452. The housing lower portion 463 and the sleeve bottom portion 451, which constitute a lower portion of the bearing portion 443, are arranged to together define a plate accommodating portion 71. The bearing portion 443 is otherwise similar in structure to the bearing portion 441 of the fan 1 according to the first preferred embodiment.

In the fan 1d, a radially inner portion of a stator core 321 is directly fixed to an outer circumferential surface 72a of a bearing middle portion 72, i.e., an outer circumferential surface of the sleeve holding portion 462. A holder 31 is arranged on a lower portion of the outer circumferential surface 72a of the bearing middle portion 72, or below the outer circumferential surface 72a of the bearing middle portion 72, and is arranged to hold the plate accommodating portion 71. An upper end portion of the holder 31 is arranged to be in axial contact with the radially inner portion of the stator core 321. The fan 1d is otherwise similar in structure to the fan 1 according to the first preferred embodiment.

In the fan 1d, no portion of the holder 31 is arranged between the sleeve holding portion 462 and the stator core 321. This makes it possible to increase the radial dimension of the entire bearing housing 46 by the thickness of the holder 31. This makes it possible to increase the radial dimension of a space inside the plate accommodating portion 71. The same is true of other preferred embodiments of the present invention described below.

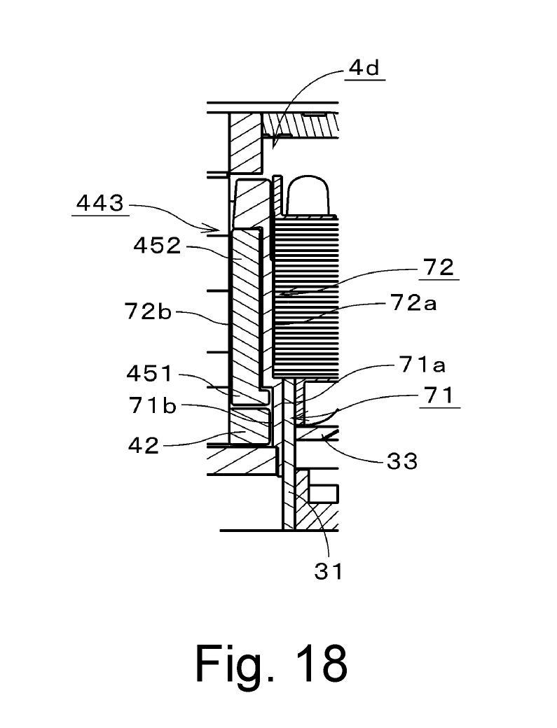

FIG. 18 is a diagram illustrating a bearing mechanism 4d according to a modification of the fifth preferred embodiment. In a bearing portion 443 of the bearing mechanism 4d, an outer circumferential surface 71a of a plate accommodating portion 71 is arranged to have a diameter greater than the diameter of an outer circumferential surface 72a of a bearing middle portion 72, and the distance between the outer circumferential surface 71a and an inner circumferential surface 71b of the plate accommodating portion 71 is arranged to be smaller than the distance between the outer circumferential surface 72a and an inner circumferential surface 72b of the bearing middle portion 72. An increase in the radial dimension of a space inside the plate accommodating portion 71 can thereby be achieved, and in the plate accommodating portion 71, each of a sleeve bottom portion 451 and a thrust plate 42 can be arranged to have an outside diameter greater than the outside diameter of a sleeve upper portion 452. The bearing mechanism 4d according to the present modification of the fifth preferred embodiment is otherwise similar in structure to the bearing mechanism 4d illustrated in FIG. 17. Each of the plate accommodating portion 71 and a holder 31 may be arranged on a lower side of a circuit board 33 in a manner similar to that illustrated in FIG. 14. An additional increase in the radial dimension of the plate accommodating portion 71 can thereby be achieved.

### Sixth Preferred Embodiment

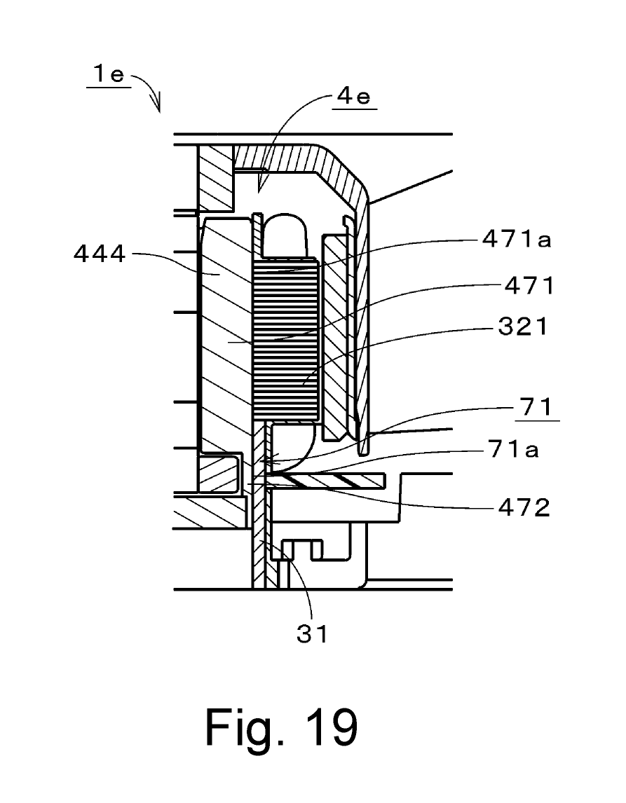

FIG. 19 is a cross-sectional view of a fan 1e according to a sixth preferred embodiment of the present invention. In the fan 1e, an outer circumferential surface of a bearing portion 444 of a bearing mechanism 4e is a cylindrical surface. That is, an outer circumferential surface 471a of a bearing upper portion 471 and an outer circumferential surface 71a of a plate accommodating portion 71, i.e., an outer circumferential surface of a bearing lower portion 472, are arranged to have the same diameter. The bearing portion 444 is otherwise similar in structure to the bearing portion 442 of the bearing mechanism 4a according to the second preferred embodiment. A stator core 321 is directly fixed to the outer circumferential surface 471a of the bearing upper portion 471. A holder 31 is arranged on a lower side of the stator core 321, and an upper end portion of the holder 31 and a radially inner portion of the stator core 321 are arranged to be in axial contact with each other. In addition, the plate accommodating portion 71 is held by the holder 31. The fan 1e is otherwise similar in structure to the fan 1a according to the second preferred embodiment.

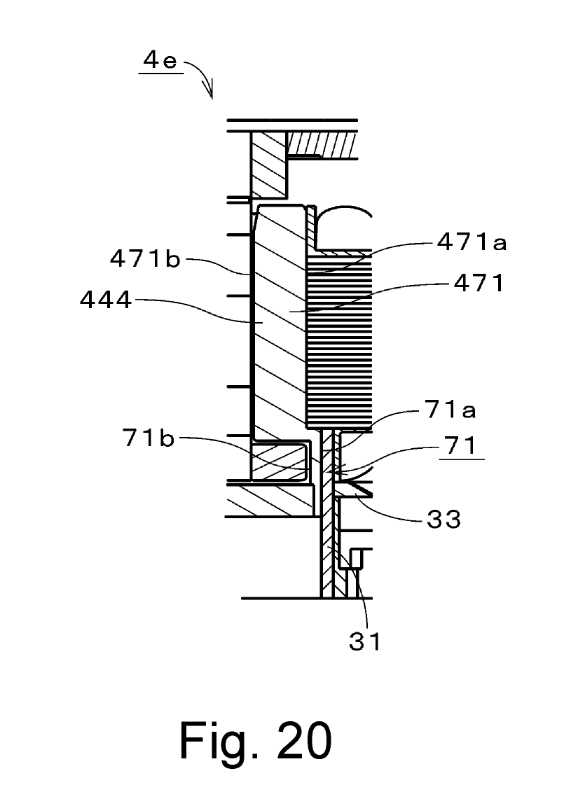

FIG. 20 is a diagram illustrating a bearing mechanism 4e according to a modification of the sixth preferred embodiment. In a bearing portion 444 of the bearing mechanism 4e, an outer circumferential surface 71a of a plate accommodating portion 71 is arranged to have a diameter greater than the diameter of an outer circumferential surface 471a of a bearing upper portion 471, and the distance between the outer circumferential surface 71a and an inner circumferential surface 71b of the plate accommodating portion 71 is arranged to be smaller than the distance between the outer circumferential surface 471a and an inner circumferential surface 471b of the bearing upper portion 471. An additional increase in the radial dimension of a space inside the plate accommodating portion 71 can thereby be achieved. Also in the bearing mechanism 4e, each of the plate accommodating portion 71 and a holder 31 may be arranged on a lower side of a circuit board 33.

While preferred embodiments of the present invention have been described above, it is to be understood that the present invention is not limited to the above-described preferred embodiments, and that a variety of modifications are possible. For example, in a modification of the first preferred embodiment, the radial dynamic pressure groove array may be defined in the outer circumferential surface of the shaft 41. The first thrust dynamic pressure groove array may be defined in the upper surface of the thrust plate 42. The second thrust dynamic pressure groove array may be defined in the lower surface of the thrust plate 42. In the bearing mechanism 4, the second thrust dynamic pressure bearing portion 692 may not necessarily be provided. Even in this case, a force which is generated during the rotation of the fan 1 to lift the impeller 12 is reduced by the magnetic attraction forces generated between the rotor magnet 22 and the stator 32, and between the rotor magnet 22 and the magnetic member 331. The same is true of the other preferred embodiments.

In a modification of each of the third and fifth preferred embodiments, the sleeve may be defined by two members. In a modification of each of the first, third, and fifth preferred embodiments, the bearing housing 46 and the thrust cap 43 may be defined by a single member. In a modification of each of the second, fourth, and sixth preferred embodiments, the bearing portion 442 or 444 and the thrust cap 43 may be defined by a single member.

The top face portion 123 of the impeller 12 is directly attached to the outer circumferential surface of the bushing 25 in each of the above-described preferred embodiments. However, in a modification of each of the above-described preferred embodiments, the top face portion 123 may be attached to the outer circumferential surface of the bushing 25 through one or more members. In a modification of each of the first and second preferred embodiments, the stator core 321 may be arranged outside the outer circumferential surface 312a of the stator fixing portion 312 with one or more members intervening therebetween. In a modification of each of the first and second preferred embodiments, only the horizontal gap 501 may be defined without the vertical gap 502 being defined.

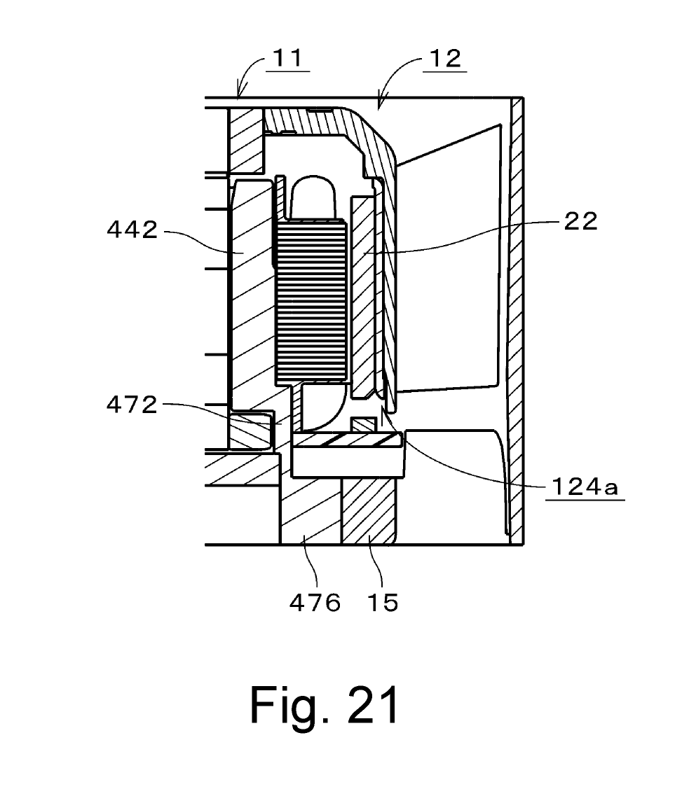

Referring to FIG. 21, in a modification of the fourth preferred embodiment, the bearing portion 442 may include an annular portion 476 arranged to extend radially outward on a lower side of the bearing lower portion 472. The base portion 15 is arranged to extend radially outward from an outer circumferential surface of the annular portion 476. Note, however, that the outer circumferential surface of the annular portion 476 is arranged radially inward of an outer circumferential surface of the rotor magnet 22. Arranging the annular portion 476 radially inward of the rotor magnet 22 makes it easy to arrange the weight on the balance correction portion 124a when the balance correction of the impeller 12 and the motor 11 is carried out.

The motor 11 may be used as a motor of a fan of another type, such as a centrifugal fan. Also, the motor 11 may be used in applications other than fans.

Features of the above-described preferred embodiments and the modifications thereof may be combined appropriately as long as no conflict arises.

The present invention is applicable to fans arranged to produce air currents. Moreover, bearing apparatuses according to preferred embodiments of the present invention may be used in applications other than fans.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A bearing apparatus comprising:
a cylindrical bearing portion;
a cap member arranged to close a bottom portion of the bearing portion;
a cylindrical holder arranged to hold the bearing portion thereinside, and including an outer circumferential surface arranged to have a stator fixed thereto;
a shaft inserted in the bearing portion; and
a thrust plate arranged to extend radially outward from a lower end portion of the shaft; wherein
the holder includes an increased diameter portion arranged to have an outside diameter greater than a diameter of the outer circumferential surface;
a portion of the bearing portion which is arranged radially inside the increased diameter portion includes a plate accommodating portion arranged to accommodate the thrust plate thereinside;
an outer circumferential surface of the plate accommodating portion is arranged to have a diameter greater than a diameter of an outer circumferential surface of a portion of the bearing portion which is on an upper side of the plate accommodating portion, and a distance between the outer circumferential surface and an inner circumferential surface of the plate accommodating portion is arranged to be smaller than a distance between the outer circumferential surface and an inner circumferential surface of the portion of the bearing portion which is on the upper side of the plate accommodating portion;
the bearing portion includes an annular surface arranged axially opposite an upper surface of the thrust plate; and
a radial dynamic pressure bearing portion arranged to generate a fluid dynamic pressure acting on a lubricating oil is defined in a radial gap defined between an inner circumferential surface of the bearing portion and an outer circumferential surface of the shaft, while a thrust dynamic pressure bearing portion arranged to generate a fluid dynamic pressure acting on the lubricating oil is defined in a thrust gap defined between the upper surface of the thrust plate and the annular surface of the bearing portion.

2. The bearing apparatus according to claim 1, wherein
the bearing portion includes:
a sleeve defined by a metallic sintered body; and
a bearing housing arranged to cover an outer circumferential surface of the sleeve;
a lower portion of the bearing housing is arranged to extend downwardly of the sleeve, and the thrust dynamic pressure bearing portion is defined between the thrust plate and a lower surface of the sleeve; and
in the plate accommodating portion, the sleeve includes a bottom portion arranged to have an outside diameter greater than an outside diameter of a portion of the sleeve which is on an upper side of the bottom portion.

3. The bearing apparatus according to claim 1, wherein the bearing portion is defined by a single metallic member.

4. The bearing apparatus according to claim 1, further comprising an annular bushing fixed to the shaft on an upper side of the bearing portion, and including an outer circumferential surface to which an impeller is capable of being attached directly or through one or more members; wherein
the bearing portion and the bushing are arranged to together define a horizontal gap extending in directions perpendicular to a central axis therebetween;
the bearing portion and the shaft are arranged to together define a seal gap therebetween on an upper side of the radial dynamic pressure bearing portion, the seal gap being arranged to have a surface of the lubricating oil defined therein; and
the seal gap is arranged to be in communication with an exterior space through the horizontal gap.

5. The bearing apparatus according to claim 4, wherein
an inner circumferential surface of the holder and the outer circumferential surface of the bushing are arranged to together define a vertical gap extending in an axial direction therebetween; and
the seal gap is arranged to be in communication with the exterior space through the horizontal gap and the vertical gap.

6. A fan comprising:
a motor; and
an impeller including a plurality of blades, and caused by the motor to rotate about a central axis to produce an air current; wherein
the motor includes:
the bearing apparatus of claim 1;
a stationary portion including a stator; and
a rotating portion including a rotor magnet arranged radially outside the stator, and supported by the bearing apparatus to be rotatable with respect to the stationary portion.

7. A fan comprising:
a motor; and
an impeller including a plurality of blades, and caused by the motor to rotate about a central axis to produce an air current; wherein
the motor includes:
the bearing apparatus of claim 1;
a stationary portion; and
a rotating portion supported by the bearing apparatus to be rotatable with respect to the stationary portion;
the rotating portion includes a rotor magnet; and
the stationary portion includes a stator arranged radially inside the rotor magnet on an upper side of the increased diameter portion.

8. The fan according to claim 7, wherein
the stationary portion further includes a circuit board arranged on a lower side of the stator, and electrically connected with the stator; and
the increased diameter portion is arranged on a lower side of the circuit board.

9. The fan according to claim 8, wherein
the increased diameter portion includes:
an annular portion arranged to extend radially outward to assume an annular shape; and
a cylindrical tubular portion arranged to extend downward from an outer edge portion of the annular portion; and
the circuit board is arranged to be in axial contact with an upper surface of the annular portion.

10. A bearing apparatus comprising:
a cylindrical bearing portion including an outer circumferential surface arranged to have a stator fixed thereto;
a cap member arranged to close a bottom portion of the bearing portion;
a shaft inserted in the bearing portion; and
a thrust plate arranged to extend radially outward from a lower end portion of the shaft; wherein
the bearing portion includes a plate accommodating portion arranged to accommodate the thrust plate thereinside;
an outer circumferential surface of the plate accommodating portion is arranged to have a diameter greater than a diameter of an outer circumferential surface of a portion of the bearing portion which is on an upper side of the plate accommodating portion, and a distance between the outer circumferential surface and an inner circumferential surface of the plate accommodating portion is arranged to be smaller than a distance between the outer circumferential surface and an inner circumferential surface of the portion of the bearing portion which is on the upper side of the plate accommodating portion;
the bearing portion includes an annular surface arranged axially opposite an upper surface of the thrust plate; and
a radial dynamic pressure bearing portion arranged to generate a fluid dynamic pressure acting on a lubricating oil is defined in a radial gap defined between an inner circumferential surface of the bearing portion and an outer circumferential surface of the shaft, while a thrust dynamic pressure bearing portion arranged to generate a fluid dynamic pressure acting on the lubricating oil is defined in a thrust gap defined between the upper surface of the thrust plate and the annular surface of the bearing portion.

11. The bearing apparatus according to claim 10, wherein
the bearing portion includes:
a sleeve defined by a metallic sintered body; and
a bearing housing arranged to cover an outer circumferential surface of the sleeve;
a lower portion of the bearing housing is arranged to extend downwardly of the sleeve, and the thrust dynamic pressure bearing portion is defined between the thrust plate and a lower surface of the sleeve; and
in the plate accommodating portion, the sleeve includes a bottom portion arranged to have an outside diameter greater than an outside diameter of a portion of the sleeve which is on an upper side of the bottom portion.

12. The bearing apparatus according to claim 10, wherein the bearing portion is defined by a single metallic member.

13. The bearing apparatus according to claim 10, further comprising an annular bushing fixed to the shaft on an upper side of the bearing portion, and including an outer circumferential surface to which an impeller is capable of being attached directly or through one or more members; wherein
the bearing portion and the bushing are arranged to together define a horizontal gap extending in directions perpendicular to a central axis therebetween;
the bearing portion and the shaft are arranged to together define a seal gap therebetween on an upper side of the radial dynamic pressure bearing portion, the seal gap being arranged to have a surface of the lubricating oil defined therein; and
the seal gap is arranged to be in communication with an exterior space through the horizontal gap.

14. The bearing apparatus according to claim 13, wherein the bushing is arranged to have an outside diameter smaller than an inside diameter of the stator.

15. A fan comprising:
a motor; and
an impeller including a plurality of blades, and caused by the motor to rotate about a central axis to produce an air current; wherein
the motor includes:
the bearing apparatus of claim 10;
a stationary portion including a stator; and
a rotating portion including a rotor magnet arranged radially outside the stator, and supported by the bearing apparatus to be rotatable with respect to the stationary portion.

16. A fan comprising:
a motor; and
an impeller including a plurality of blades, and caused by the motor to rotate about a central axis to produce an air current; wherein
the motor includes:
the bearing apparatus of claim 10;
a stationary portion; and
a rotating portion supported by the bearing apparatus to be rotatable with respect to the stationary portion;
the rotating portion includes a rotor magnet; and
the stationary portion includes a stator arranged radially inside the rotor magnet on an upper side of the plate accommodating portion.

17. The fan according to claim 16, wherein
the stationary portion further includes a circuit board arranged on a lower side of the stator, and electrically connected with the stator; and
the plate accommodating portion is arranged on a lower side of the circuit board.

18. The fan according to claim 17, wherein
the bearing portion includes a shoulder portion defined between the plate accommodating portion and the portion of the bearing portion which is on the upper side of the plate accommodating portion; and
the circuit board is arranged to be in axial contact with an upper surface of the shoulder portion.

19. A bearing apparatus comprising:
a cylindrical bearing portion including an outer circumferential surface arranged to have a stator fixed thereto;
a cap member arranged to close a bottom portion of the bearing portion;
a holder arranged to hold a lower portion of the bearing portion on a lower side of the outer circumferential surface arranged to have the stator fixed thereto, the lower portion of the bearing portion including a plate accommodating portion;
a shaft inserted in the bearing portion; and
a thrust plate arranged to extend radially outward from a lower end portion of the shaft, and accommodated inside the plate accommodating portion; wherein
the bearing portion includes an annular surface arranged axially opposite an upper surface of the thrust plate; and
a radial dynamic pressure bearing portion arranged to generate a fluid dynamic pressure acting on a lubricating oil is defined in a radial gap defined between an inner circumferential surface of the bearing portion and an outer circumferential surface of the shaft, while a thrust dynamic pressure bearing portion arranged to generate a fluid dynamic pressure acting on the lubricating oil is defined in a thrust gap defined between the upper surface of the thrust plate and the annular surface of the bearing portion.

20. The bearing apparatus according to claim 19, wherein
the bearing portion includes:
a sleeve defined by a metallic sintered body; and
a bearing housing arranged to cover an outer circumferential surface of the sleeve; and
a lower portion of the bearing housing is arranged to extend downwardly of the sleeve, and the thrust dynamic pressure bearing portion is defined between the thrust plate and a lower surface of the sleeve.

21. The bearing apparatus according to claim 19, wherein an outer circumferential surface of the plate accommodating portion is arranged to have a diameter greater than a diameter of an outer circumferential surface of a portion of the bearing portion which is on an upper side of the plate accommodating portion, and a distance between the outer circumferential surface and an inner circumferential surface of the plate accommodating portion is arranged to be smaller than a distance between the outer circumferential surface and an inner circumferential surface of the portion of the bearing portion which is on the upper side of the plate accommodating portion.

22. The bearing apparatus according to claim 21, wherein
the bearing portion includes:
a sleeve defined by a metallic sintered body; and
a bearing housing arranged to cover an outer circumferential surface of the sleeve;
a lower portion of the bearing housing is arranged to extend downwardly of the sleeve, and the thrust dynamic pressure bearing portion is defined between the thrust plate and a lower surface of the sleeve; and
in the plate accommodating portion, the sleeve includes a bottom portion arranged to have an outside diameter greater than an outside diameter of a portion of the sleeve which is on an upper side of the bottom portion.

23. The bearing apparatus according to claim 22, wherein the sleeve includes:
an upper sleeve including an inner circumferential surface arranged to define the radial gap together with the outer circumferential surface of the shaft, the upper sleeve defining the portion of the sleeve which is on the upper side of the bottom portion; and
a lower sleeve including a lower surface arranged to define the thrust gap together with the upper surface of the thrust plate, and arranged on a lower side of the upper sleeve to define the bottom portion.

24. The bearing apparatus according to claim 22, wherein the thrust plate is arranged to have an outside diameter greater than an outside diameter of the portion of the sleeve which is on the upper side of the bottom portion.

25. The bearing apparatus according to claim 19, wherein the bearing portion is defined by a single metallic member.

26. A fan comprising:
a motor; and
an impeller including a plurality of blades, and caused by the motor to rotate about a central axis to produce an air current; wherein
the motor includes:
the bearing apparatus of claim 19;
a stationary portion including a stator; and
a rotating portion including a rotor magnet arranged radially outside the stator, and supported by the bearing apparatus to be rotatable with respect to the stationary portion.
